(19) United States
(12) Patent Application Publication
(10) Pub. No.: US 2024/0338018 A1
(43) Pub. Date: Oct. 10, 2024

(54) Copper Cable Fault Training System and Copper Cable Fault Creation Devices

(71) Applicant: AT&T Intellectual Property I, L.P., Atlanta, GA (US)

(72) Inventors: Jermaine Hawthorne, Daytona Beach, FL (US); Alan P. Seixas, Pembroke Pines, FL (US)

(73) Assignee: AT&T Intellectual Property I, L.P., Atlanta, GA (US)

(21) Appl. No.: 18/132,544

(22) Filed: Apr. 10, 2023

(51) Int. Cl. G05B 23/02; G06F 30/20

(52) U.S. Cl. CPC G05B 23/0243; G06F 30/20; G05B 2223/06

(57) ABSTRACT

A copper cable fault creation (“CCFC”) device can include a servo with a servo arm that is physically attached to a variable resistor. A resistance value of the variable resistor can be controlled by the servo arm. The variable resistor is also electrically connected to a copper cable. The CCFC device can also include a relay that is electrically connected to the variable resistor and to the copper cable. When the relay is activated, the relay can cause a fault on the copper cable. The relay can also be electrically connected to a switch via a control wire pair through which the relay can be activated.

### BACKGROUND

Since the nineteenth century, copper cables have been used as a wired communication medium to provide fixed telephone service and were later adapted to provide broadband Internet and cable television services. In recent years, telecommunications service providers have begun installing fiber optic cables for new cable installations, but existing copper cable remains a vital part of the wired communications infrastructure. For this reason, telecommunications service providers must maintain existing copper cable infrastructure and promptly address faults to minimize service interruptions.

In the past, cable technicians would receive in-field training to locate and repair cable faults. More recently, static cable faults have been simulated using specific configurations of resistors, capacitors, coils, and other electronic components on varying lengths of cable. Although these static fault simulators were suitable for use with early cable testing equipment, sophisticated cable testing equipment is capable of detecting these individual electronic components, resulting in inaccurate and incomplete diagnostic results of a simulated fault. Since static faults by nature are unchangeable, a cable technician would not be able to observe the cable after the fault was repaired or if the fault recurred. Moreover, existing training laboratories are either large and stationary, requiring technicians to travel for training, or small and portable and cannot accurately simulate cable fault conditions.

### SUMMARY

Concepts and technologies disclosed herein are directed to a copper cable fault training system and copper cable fault creation (“CCFC”) devices. According to one aspect disclosed herein, a CCFC device can include a servo with a servo arm that is physically attached to a variable resistor. A resistance value of the variable resistor can be controlled by the servo arm. The variable resistor is also electrically connected to a copper cable. The CCFC device can also include a relay that is electrically connected to the variable resistor and to the copper cable. When the relay is activated, the relay can cause a fault on the copper cable.

The relay can also be electrically connected to a switch via a control wire pair through which the relay can be activated. The relay can be electrically connected to a switch via a control wire pair through which the relay can be activated. In some embodiments, the switch can have multiple positions, such as in the case of a double pole, double throw (“DPDT”) switch. When changed to a first position, the switch can cause the relay to change to a first state of a plurality of states. The fault can be a first fault associated with the first state. When the relay is activated in the first state, the relay can cause the first fault on the copper cable. When changed to a second position, the switch can cause the relay to change to a second state of the plurality of states. The fault can be a second fault associated with the second state. When the relay is activated in the second state, the relay can cause the second fault on the copper cable. When changed to a third position, the switch can cause the relay to change to a third state of the plurality of states. The fault can be a third fault associated with the third state. When the relay is activated in the third state, the relay can cause the third fault on the copper cable. The first fault, the second fault, and the third fault can each include a ground fault, a short circuit fault, or a crosstalk fault. In other embodiments, when activated, the switch can cause the relay to change to a specific state associated with an open circuit fault.

In some embodiments, the CCFC device also includes a microcontroller that is electrically connected to the service. The microcontroller can have instructions stored thereon that, when executed by the microcontroller, cause the microcontroller to perform operations. In particular, the microcontroller can receive a resistance value for the variable resistor and can instruct the servo to adjust the variable resistor to the resistance value. In addition, the microcontroller can determine a new resistance value and can instruct the servo to adjust the variable resistor to the new resistance value. By adjusting the variable resistor from the resistance value to the new resistance value, the fault on the copper cable can simulate a specific environmental condition. For example, the specific environment condition can be a moisture condition that contributed, at least in part, to the fault created on the copper cable. Other environment conditions such as wind (e.g., for aerial installations of the copper cable) may be considered for simulation.

In some embodiments, the CCFC device includes a microcontroller interface that allows the CCFC device to connect to a microcontroller. In these embodiments, the microcontroller also can be connected to at least one additional CCFC device. In this manner, a single microcontroller can control the variable resistance and relay states of multiple CCFC devices deployed on the copper cable or multiple copper cables.

According to another aspect disclosed herein, a microcontroller of a CCFC device can receive a request to create a fault on a copper cable. The microcontroller can determine a resistance value for a variable resistor and a state for a relay. The resistance value and the state can cause the fault to be created on the copper cable. The microcontroller can instruct a servo that is physically connected to the variable resistor (e.g., via a servo arm) to adjust the variable resistor to the resistance value. The microcontroller also can activate the relay to the state, thereby creating the fault on the copper cable.

The microcontroller can receive the request to create the fault on the copper cable via an input device connected to the microcontroller. The microcontroller can receive the request to create the fault on the copper cable via a wired or wireless network connection.

In some embodiments, the request can specify the fault, at least in part, by specifying the resistance value for the variable resistor and the state for the relay. In other embodiments, the microcontroller can be programmed with a predetermined set of faults, in which case the request can specify the fault from the predetermined set of faults.

According to another aspect disclosed herein, a copper cable fault training system can include a copper cable, a crossbox testing equipment connected to the copper cable, a terminal testing equipment also connected to the copper cable, a power supply, a plurality of switches electrically connected to the power supply, and a plurality of CCFC devices. Each of the CCFC devices can be electrically connected to a switch of the plurality of switches via a control wire pair and to the copper cable. Each of the CCFC devices can be powered by the copper cable. Each of the CCFC devices can be configured as the CCFC device described above. The plurality of CCFC devices can be positioned at different positions along the copper cable to simulate a plurality of faults in a real-world copper cable installation.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an example copper cable fault training system, according to an illustrative embodiment.

FIGS. 2A-2B are block diagrams illustrating example operating environments in which copper cable fault creation (“CCFC”) devices can be implemented, according to illustrative embodiments.

FIGS. 3A-3B are block diagrams illustrating aspects of two different relay wire configurations, according to illustrative embodiments.

FIG. 4 is a flow diagram illustrating a method for creating a fault on a copper cable via a CCFC device, according to an illustrative embodiment.

FIG. 5 is a table diagram illustrating an example cable fault key, according to an illustrative embodiment.

FIGS. 6-11 are photographs of different aspects of example CCFC devices and an example copper cable fault training system, according to illustrative embodiments.

FIG. 12 is a block diagram illustrating an example computer system capable of implementing aspects of the embodiments presented herein.

FIG. 13 is a block diagram illustrating an example mobile device capable of implementing aspects of the embodiments disclosed herein.

FIG. 14 is a diagram illustrating a network, according to an illustrative embodiment.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, vehicles, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of the concepts and technologies disclosed herein for a copper cable fault training system and copper cable fault creation devices will be described.

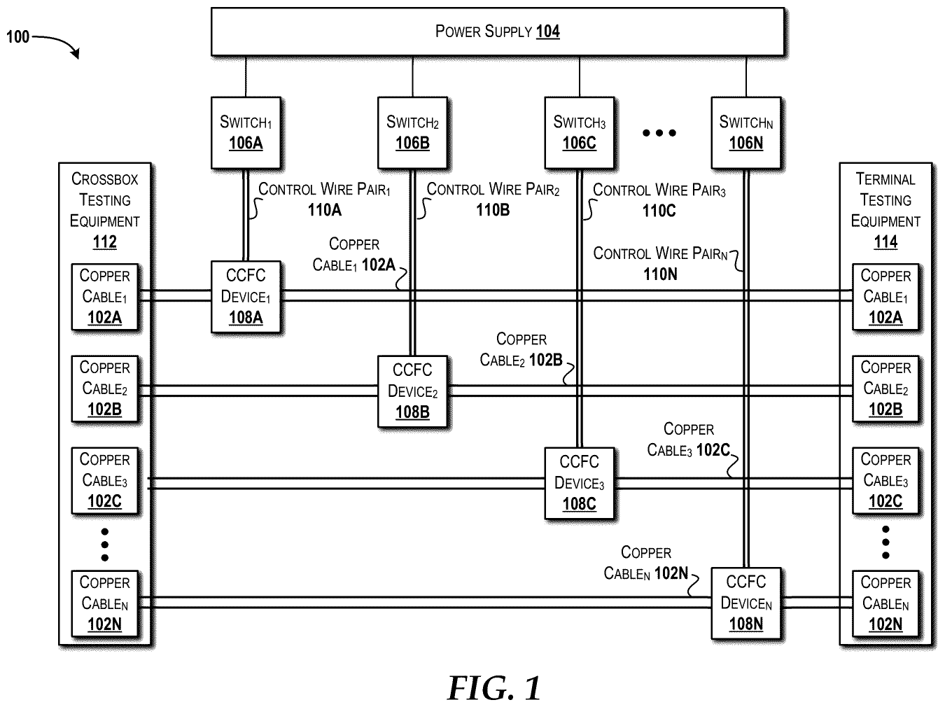

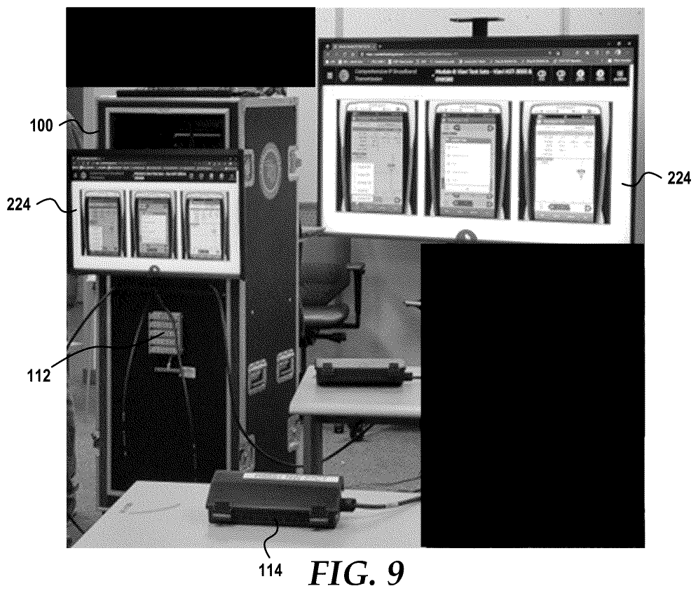

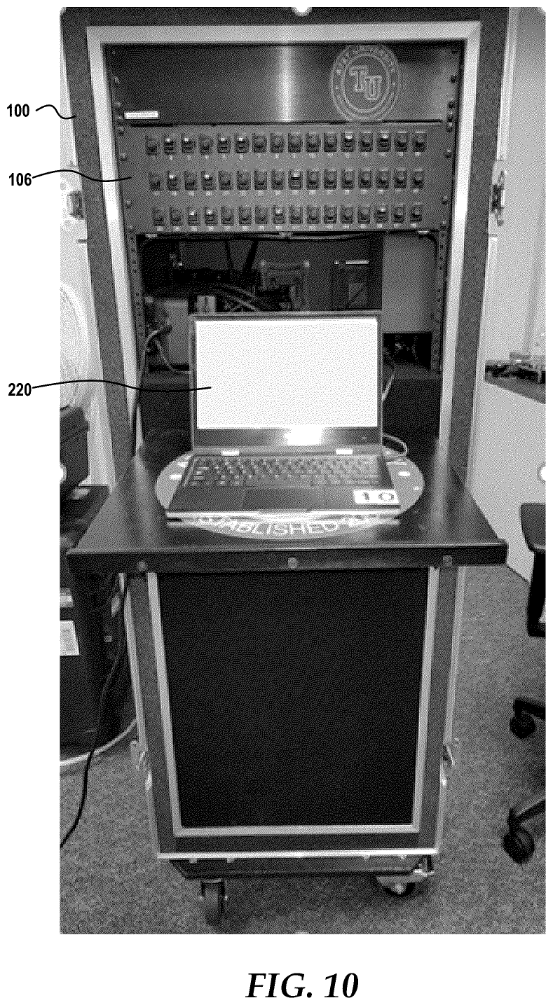

Referring now to FIG. 1, aspects of a cable fault training system 100 will be described, according to an illustrative embodiment. The cable fault training system 100, in some embodiments, is contained within a portable housing (an example of which is shown in FIGS. 9 and 10) with wheels that allow the cable fault training system 100 to be easily moved to accommodate cable fault training sessions held at different locations. The cable fault training system 100 can contain multiple copper cables 102A-102N (hereinafter referred to collectively as “copper cables 102” or individually as “copper cable 102”), although the cable fault training system 100 may contain only one copper cable 102 in some implementations. Each of the copper cables 102 can be any length. In some embodiments, each of the copper cables 102 is representative of a portion of a real-world copper cable installation. As such, the copper cables 102 may be cut to specific lengths and may include connectors, splices, and/or other components as in the real-world copper cable installation. The real-world copper cable installation can be derived from a map that includes location data (e.g., street address and/or latitude/longitude coordinates). The cable fault training system 100 can contain hundreds or even thousands of feet of the copper cable 102. In this manner, the cable fault training system 100 can accurately reflect real-world copper cable installations in a portable package.

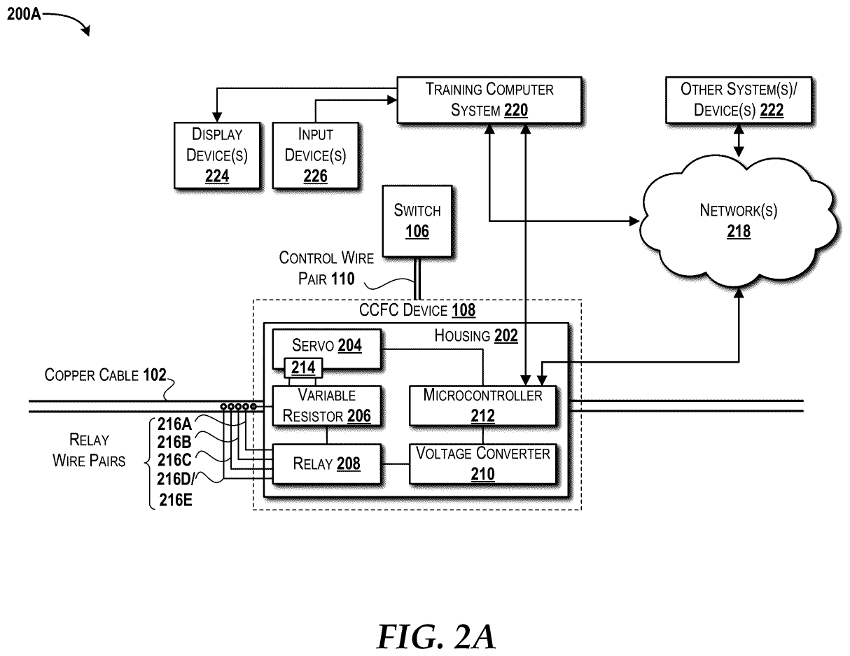

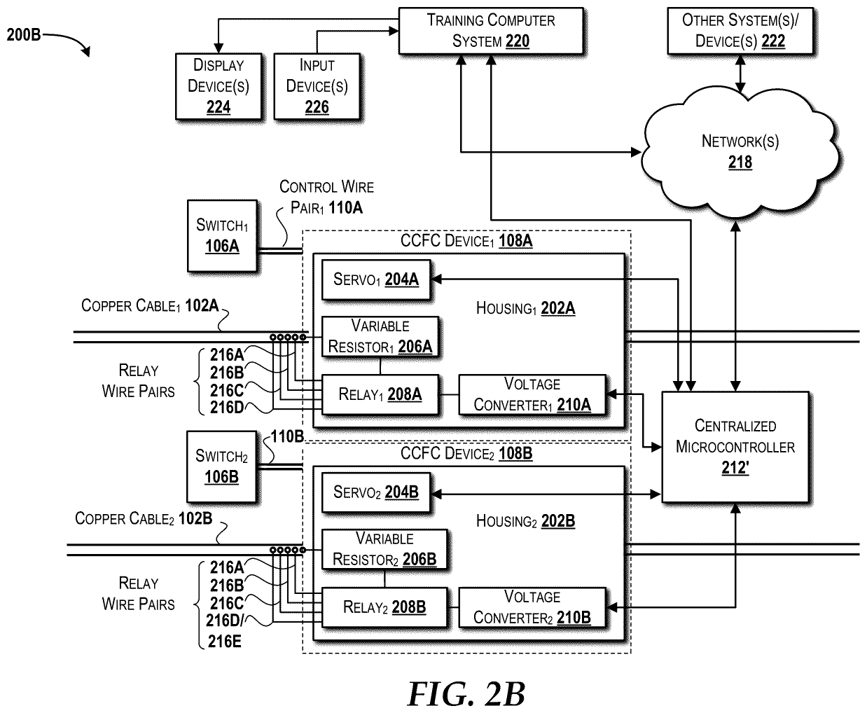

In the illustrated example, the cable fault training system 100 also contains a power supply 104 that provides power to a plurality of switches 106A-106N (hereinafter referred to collectively as “switches 106” or individually as “switch 106”) that are electrically connected to a plurality of copper cable fault creation (“CCFC”) devices 108A-108N (hereinafter referred to collectively as “CCFC devices 108” or individually as “CCFC device 108”) via a plurality of control wire pairs 110A-110N (hereinafter referred to collectively as “control wire pairs 110” or individually as “control wire pair 110”) through which the CCFC devices 108 can be activated. Upon toggling a given switch 106, the corresponding CCFC device 108 is activated, which creates a fault on the corresponding copper cable 102. It should be noted that the power supply 104 does not power the CCFC devices 108, which instead receive power directly from the copper cables 102 to which they are connected. More particularly, a relay (introduced in FIG. 2A) of the CCFC device 108 is activated and enters a specific state, which causes a specific fault. In some embodiments, the switches 106 are double pole double throw (“DPDT”) switches that can be changed to multiple positions, each associated with a different state and corresponding fault. In these embodiments, each position can activate the relay in a different state based upon, in part, the electrical polarity of the circuit created upon toggling the switch 106.

Each of the CCFC devices 108A-108N is electrically connected to the copper cables 102A-102N, respectively. It should be understood, however, that one or more of the copper cables 102 may be connected to multiple CCFC devices 108. For example, the copper cable₁ 102A may be connected to the CCFC device₁ 108A and the CCFC device₂ 108B. Additional details about the CCFC devices 108 will be provided below with reference to FIGS. 2A-2B.

The illustrated copper cables 102 are also attached to crossbox testing equipment 112 and terminal testing equipment 114. In an alternative configuration, each of the copper cables 102 can be attached to different terminal testing equipment 114. The crossbox testing equipment 112 and the terminal testing equipment 114 allow a technician to conduct tests on the copper cables 102 to diagnose the fault(s) created by the CCFC device(s) 108. Since the copper cables 102 are clean (i.e., faultless), the CCFC devices 108 can be added anywhere along the copper cables 102 and can be activated/powered-on via the control wire pairs 110 that are separate from the copper cables 102. In this manner, the crossbox and terminal equipment 112/114 would only see the fault(s) created by the CCFC devices 108 and not the CCFC devices 108 themselves. This also allows faults to be turned on and off as needed, such as to allow a technician to test the copper cables 102 to see how the testing equipment performs when no fault is present, when a fault is present (i.e., created by the CCFC device 108), and then after the fault has been removed to simulate a repaired copper cable. In a classroom environment, the dynamic fault creation capability of the CCFC devices 108 allows an instructor to dynamically adjust their training to each student. For example, if a student has already resolved all basic faults, the instructor can activate more and more difficult faults to challenge that student. Similarly, the instructor also can adjust training to present less difficult faults to students who are struggling. The dynamic nature of how faults are created using the CCFC devices 108 also eliminates cheating because each student can be tested on a unique fault.

Turning now to FIG. 2A, an operating environment 200A in which a CCFC device 108 can be implemented will be described, according to an illustrative embodiment. The operating environment 200A includes a copper cable 102, a switch 106, a CCFC device 108, and a control wire pair 110 introduced above with respect to FIG. 1. The illustrated CCFC device 108 includes a housing 202 that contains a servo 204, a variable resistor 206, a relay 208, a voltage converter 210, and a microcontroller 212.

The servo 204 can be electrically connected to the microcontroller 212, which can instruct the servo 204 to manipulate a servo arm 214 to adjust a resistance value of the variable resistor 206 that is electrically connected to the copper cable 102. The variable resistor 206 can be a potentiometer selected for a range of resistance values suitable for creating, in part, specific faults on the copper cable 102. The variable resistor 206 also is electrically connected to the relay 208 that can be controlled by the microcontroller 212. In the illustrated example, the relay 208 and the microcontroller 212 are electrically connected through the voltage converter 210, which enables a step-down voltage conversion from 12V nominal utilized by the relay 208 to 5V nominal utilized by the microcontroller 212 (e.g., ARDUINO or similar microcontroller), although the microcontroller 212 used may be suitable for other nominal voltages (e.g., 12V) without the need for a voltage converter.

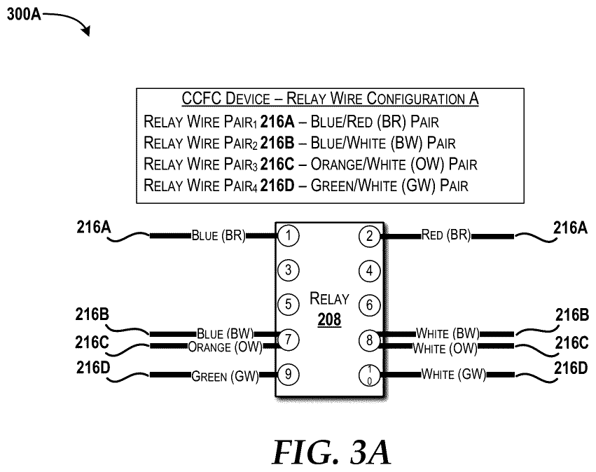

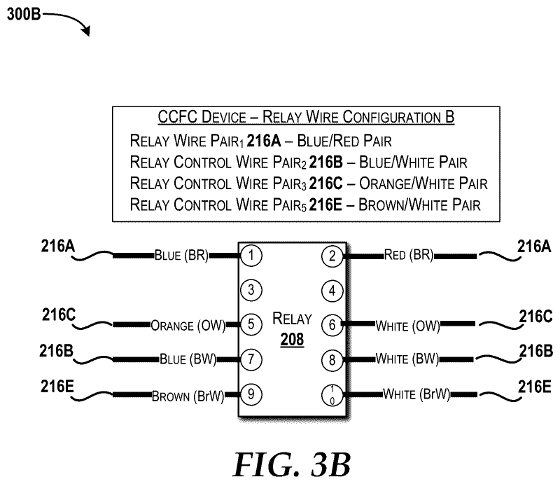

The relay 208 is electrically connected to the copper cable 102 via a plurality of relay wire pairs 216A-216E. The plurality of relay wire pairs 216A-216E can be configured in different ways depending upon the type of fault to be created by the CCFC device 108. Additional details about two possible configurations for the plurality of relay wire pairs 216A-216E will be described below with reference to FIGS. 3A-3B. When the switch 106 is powered on, the control wire pair 110 completes a circuit with the CCFC device 108 and triggers the microcontroller 212 to set a resistance value of the variable resistor 206 and change the state of the relay 208, thereby completing a circuit with at least a portion of the plurality of wire pairs 216A-216E and creating a specific fault on the copper cable 102. In embodiments where the switch 106 has multiple positions (e.g., a DPDT switch), each position can activate the relay 208 in a different state based upon, in part, the electrical polarity of the circuit created upon toggling the switch 106 to a certain position.

In the illustrated example, the CCFC device 108 is shown operating in communication with one or more networks 218. In particular, the microcontroller 212 can include one or more network interfaces (not shown) that enable communications with the network(s) 218 and, in turn, a training computer system 220 and/or one or more other systems and/or devices 222. The microcontroller 212 can be directly connected to the training computer system 220 and/or the other system(s) and/or device(s) 222 via a universal serial bus (“USB”), for example. In this manner, the microcontroller 212 can be remotely controlled, programmed, updated, or interacted with in some other way.

The network(s) 218 can include one or more local area networks (“LANs”) and/or one or more wide area networks (“WANs”). A LAN can provide wireless connectivity via any Institute of Electrical and Electronics Engineers (“IEEE”) 802.11X technology (WI-FI) and/or wired connectivity via IEEE 802.3 (Ethernet). A LAN can be provided by one or more routers and/or access points. A LAN can include one or more modems (not shown) (e.g., cellular, cable, digital subscriber line “DSL”, satellite, and/or fiber) that provide connectivity to one or more WANs, such as the Internet. The network(s) 218 additionally or alternatively can include one or more personal area networks (“PANs”) that facilitate communication via a short-range radio communications technology such as BLUETOOTH or BLUETOOTH Low Energy (“LE”). The network(s) 218 additionally or alternatively can include one or more mobile telecommunications networks. Other network types and network technologies are contemplated.

The training computer system 220 can be used to present training materials (e.g., slideshow presentations, video, images, and/or the like) via one or more display devices 224, such as monitors, televisions, projectors, and/or the like. A user (e.g., a teacher) can interact with the training computer system 220 via one or more input devices 226, such as mouse, keyboard, touchpad, touchscreen, joystick, controller, and/or the like. The training computer system 220 also can present/share training materials remotely to the other system(s)/device(s) 222 via the network(s) 218. The training computer system 220 also can interact with the microcontroller 212 such as to update the firmware and/or to program the microcontroller 212. In some embodiments, the training computer system 220, the display device(s) 224, the input device(s) 226, or some combination thereof can be integrated as part of the cable fault training system 100.

Turning now to FIG. 2B, another operating environment 200B in which CCFC devices 108 can be implemented will be described, according to an illustrative embodiment. The operating environment 200B includes two copper cables 102A, 102B, two switches 106A, 106B, two CCFC devices 108A, 108B, and two control wire pairs 110A, 110B introduced above with respect to FIG. 1. Each of the CCFC devices 108A, 108B includes, respectively, a housing 202A, 202B that contains a servo 204A, 204B, a variable resistor 206A, 206B, a relay 208A, 208B, and a voltage converter 210A, 210B. Notably, the CCFC devices 108A, 108B do not have a dedicated microcontroller 212 as shown in FIG. 2A, and instead, are each shown operating in communication with a centralized microcontroller 212′. Although two CCFC devices 108 are shown in the FIG. 2B, any number of CCFC devices 108 can be controlled by the centralized microcontroller 212′. The CCFC devices 108 shown in FIG. 2B are otherwise configured like the single CCFC device 108 shown in FIG. 2A.

Turning now to FIG. 3A, a first relay wire configuration (shown as “relay wire configuration A”) 300A will be described, according to an illustrative embodiment. The first relay wire configuration 300A enables the relay 208 to introduce, at least in part, ground faults, short circuit faults, and crosstalk faults on the copper cables 102 depending upon the state of the relay 208 and which of the relay wire pairs 216A-216D are activated. Those skilled in the art will appreciate that the wiring configuration may change depending upon the manufacturer and part number of the relay 208. The illustrated example is representative of KEMET EC2-12TNU, which includes ten through-hole-style pinouts labeled “1” through “10.” In particular, pin outs “1” and “2” are used for control wires and provide +/−12V to switch a fault on and off; pin outs “3” through “6” are not used in the first relay wire configuration 300A; pin outs “7” and “8” always maintain continuity to the assigned copper cable 102; and pin outs “9” and “10” are attached to the variable resistor 206. The physical dimensions (i.e., length, width, height, pinout spacing, pinout size, and the like), the electrical specifications (i.e., temperature operating range, coil voltage, coil resistance, switching power, switching voltage, switching current, and the like), and other specifications of the relay 208 may be selected depending upon the unique requirements of a given implementation. Each of the relay wire pairs 216A-216D is color labeled and connected to two of the pinouts. In particular, a blue/red (BR) pair 216A is connected to pins 1 and 2 of the relay 208; a blue/white (BW) pair 216B is connected to pins 7 and 8 of the relay 208; an orange/white (OW) pair 216C also is connected to pins 7 and 8 of the relay 208; and a green/white (GW) pair 216D is connected to pins 9 and 10 of the relay 208.

Turning now to FIG. 3B, a second relay wire configuration (shown as “relay wire configuration B”) 300B will be described, according to an illustrative embodiment. The second relay wire configuration 300B enables the relay 208 to introduce, at least in part, open circuit faults on the copper cables 102 depending upon the state of the relay 208 and which of the relay wire pairs 216A, 216B, 216C, 216E are activated. Those skilled in the art will appreciate that the wiring configuration may change depending upon the manufacturer and model of the relay 208. The illustrated example is representative of KEMET EC2-12TNU, which includes ten through-hole-style pinouts labeled “1” through “10.” In particular, pin outs “1” and “2” are used for control wires and provide +/−12V to switch a fault on and off; pin outs “3” and “4” are not used in the second relay wire configuration 300B; pin outs “7” and “8” always maintain continuity to the assigned copper cable 102; pin outs “5” and “6” are connected to pin outs “7” and “8” when the relay 208 is not activated (i.e., no fault); pin outs “7” and “8” switch to pin outs “9” and “10” when the relay 208 is activated, which adds the value of the variable resistor 206 and/or high open load coils. The physical dimensions (i.e., length, width, height, pinout spacing, pinout size, and the like), the electrical specifications (i.e., temperature operating range, coil voltage, coil resistance, switching power, switching voltage, switching current, and the like), and other specifications of the relay 208 may be selected depending upon the unique requirements of a given implementation. Each of the relay wire pairs 216A, 216B, 216C, 216E is color labeled and connected to two of the pinouts. In particular, the blue/red (BR) pair 216A is connected to pins 1 and 2 of the relay 208; the blue/white (BW) pair 216B is connected to pins 7 and 8 of the relay 208; the orange/white (OW) pair 216C is connected to pins 5 and 6 of the relay 208; and a brown/white (BrW) pair 216E is connected to pins 9 and 10 of the relay 208.

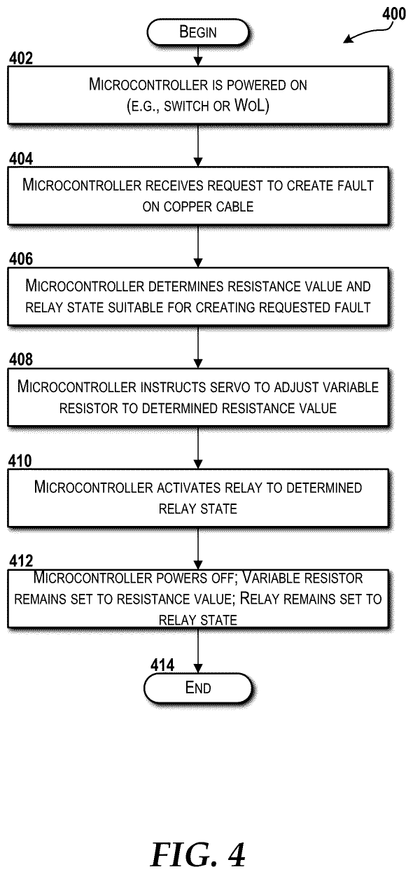

Turning now to FIG. 4, a method 400 for creating a fault on a copper cable 102 via a CCFC device 108 will be described, according to an illustrative embodiment. It should be understood that the operations of the method disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems or devices, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors, or components thereof, and/or one or more other computing systems, network components, and/or devices disclosed herein, and/or virtualizations thereof, to perform operations.

For purposes of illustrating and describing some of the concepts of the present disclosure, the method 400 will be described as being performed, at least in part, by the microcontroller 212. It should be understood that additional and/or alternative devices can provide the functionality described herein via execution of one or more modules, applications, and/or other software. In some embodiments, the microcontroller 212 and the functionality of the CCFC device(s) 108 are implemented as part of a field programmable gateway array (“FPGA”). Thus, the illustrated embodiments are illustrative, and should not be viewed as being limiting in any way.

The method 400 begins and proceeds to operation 402. At operation 402, the microcontroller 212 is powered on. In some embodiments, the microcontroller 212 can be powered on via a switch, such as the switch 106. In these embodiments, the switch 106 may be a single pole, single throw (“SPST”) switch that, when toggled, powers the microcontroller 212. In some other embodiments, the microcontroller 212 can be powered on via a wake-on-LAN message received via the network 218. The microcontroller 212, in other embodiments, can be powered on via a physical switch on the microcontroller 212 itself. Alternatively, the microcontroller 212 can be powered on via another system, such as the training computer system 220, that is directly connected to the microcontroller 212 via a wired (e.g., USB or Ethernet) or wireless connection (e.g., BLUETOOTH or WI-FI).

From operation 402, the method 400 proceeds to operation 404. At operation 404, the microcontroller 212 receives a request to create a fault on the copper cable 102. The request can specify a resistance value for the variable resistor 206 and a state for the relay 208, which combined can be used to create the fault on the copper cable. In some embodiments, the microcontroller 212 can be programmed with a predetermined set of faults, each of which can be associated with a particular resistance value and relay state. In these embodiments, the request can specify a fault from the predetermined set of faults. The microcontroller 212 can receive the request via an input device that is connected to the microcontroller 212 via a wired (e.g., USB or Ethernet) or wireless (e.g., BLUETOOTH or WI-FI) connection. The input device may be a standalone input device such as a keyboard, mouse, touchpad, touchscreen, and/or the like. Alternatively, the input device may be provided through another system/device such as the training computer system 220 and/or the other system(s)/device(s) 222. The microcontroller 212 can receive the request via a network connection, such as a wireless network connection or a wired network connection to the network(s) 218, in which case the microcontroller 212 can include an on-board network interface, such as s WI-FI interface and/or an Ethernet interface.

From operation 404, the method 400 proceeds to operation 406. At operation 406, the microcontroller 212 determines the resistance value and the relay state that is suitable for creating the requested fault. As mentioned above, the request can specify the resistance value and the relay state or can specify a fault from a predetermined set of faults. For the former, the microcontroller 212 can parse the request to obtain the resistance value and the relay state. For the latter, the microcontroller 212 can determine the resistance value and the relay state that are associated with the specified fault. The resistance value and the relay state may be associated with specific faults within a table programmed on the microcontroller 212.

From operation 406, the method 400 proceeds to operation 408. At operation 408, the microcontroller 212 instructs the servo 204 to adjust the variable resistor 206 to the determined resistance value. The servo 204 adjusts the variable resistor 206 to the determined resistance value and then powers off. The variable resistor 206 then sets the resistance value until the microcontroller 212 instructs the servo 204 to adjust the variable resistor 206 again, such as to create a new fault on the copper cable 102. From operation 408, the method 400 proceeds to operation 410. At operation 410, the microcontroller 212 activates the relay 208 to the determined relay state. The relay 208 is activated in the determined relay state until the microcontroller 212 instructs the relay 208 to activate in a different state, such as to create a new fault on the copper cable 102.

From operation 410, the method 400 proceeds to operation 412. At operation 412, the microcontroller 212 powers off. The variable resistor 206 remains set to the resistance value and regulates the current on the copper cable 102 accordingly to create, in part, the requested fault until a new request is received (e.g., to change the resistance value). The relay 208 remains set to the relay state and functions accordingly to create, in part, the requested fault until a new request is received (e.g., to change the relay state).

From operation 412, the method 400 proceeds to operation 414. The method 400 can end at operation 414.

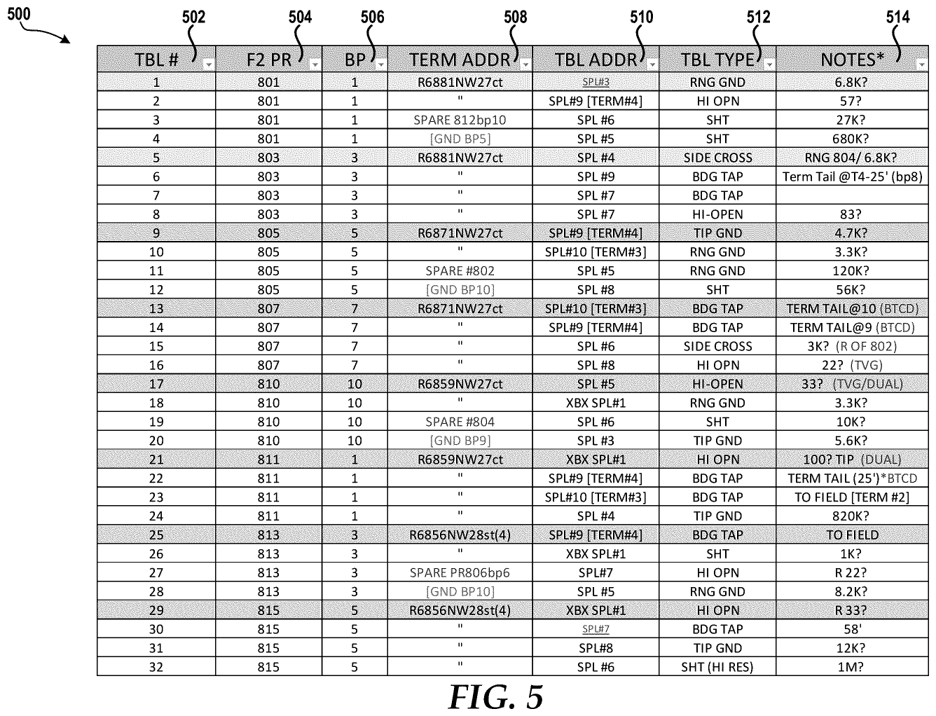

Turning now to FIG. 5, a copper cable fault key 500 will be described, according to an illustrative embodiment. The copper cable fault key 500 provides relevant information for each fault. A first column 502 provides a trouble number (“TBL #”) to uniquely identify each fault and corresponding CCFC device 108 (1, 2, 3 . . . ). A second column 504 identifies the copper cable 108 on which the fault has been created. A third column 506 uniquely identifies the binding post (“BP”) to which the copper cable 108 is attached (e.g., on the crossbox testing equipment 112 and/or the terminal testing equipment 114). A fourth column 508 uniquely identifies each terminal testing equipment 114 associated with the faults via an “address.” A fifth column 510 uniquely identifies each fault (“TBL”) via an “address,” such as at splice number one (“SPL #1”) or at crossbox splice number 1 (“XBX SPL #1”). A sixth column 512 identifies the trouble/fault type (“TBL Type”), such as ring ground (“RNG GND”), high open (“HI OPN”), short (“SHT”), side crosstalk (“SIDE CROSS”), or bridge tap (“BDG TAP”) in the illustrated example. A seventh column 514 provides relevant notes for each of the faults.

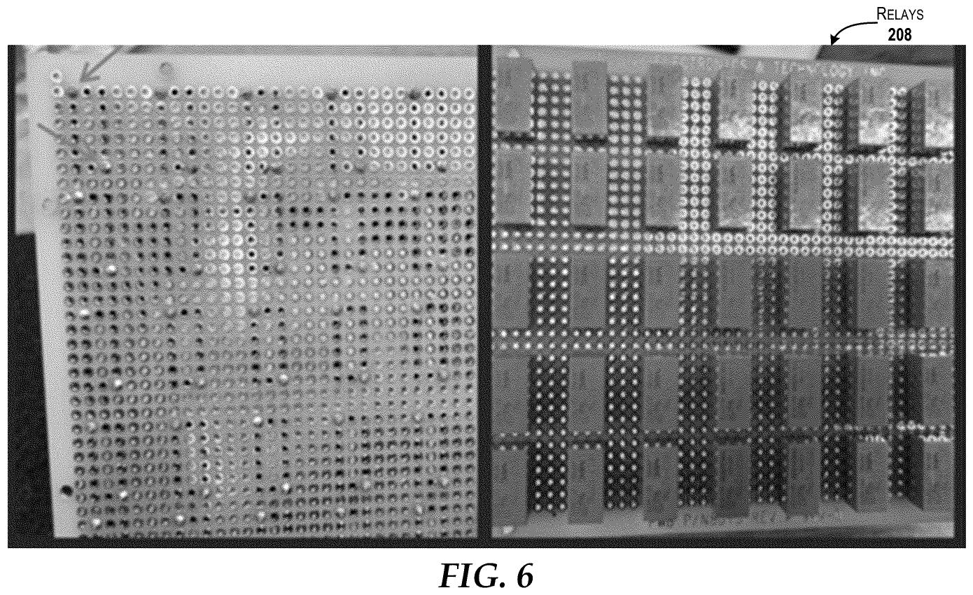

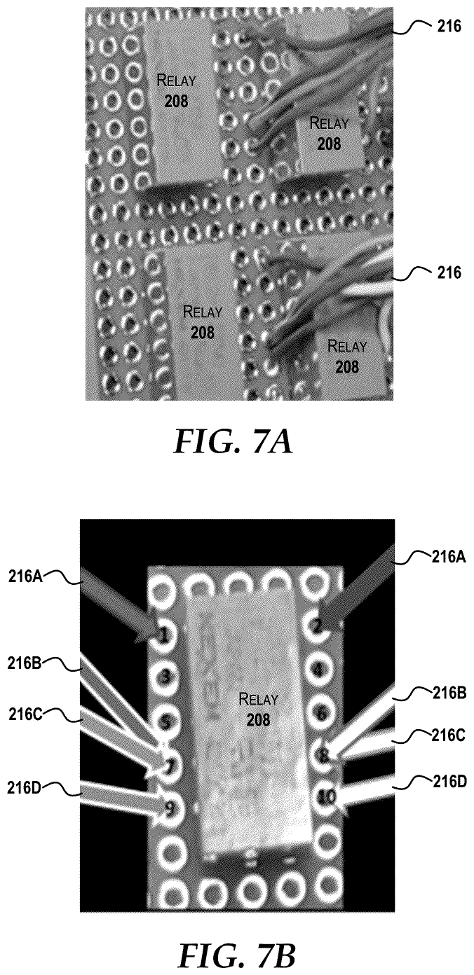

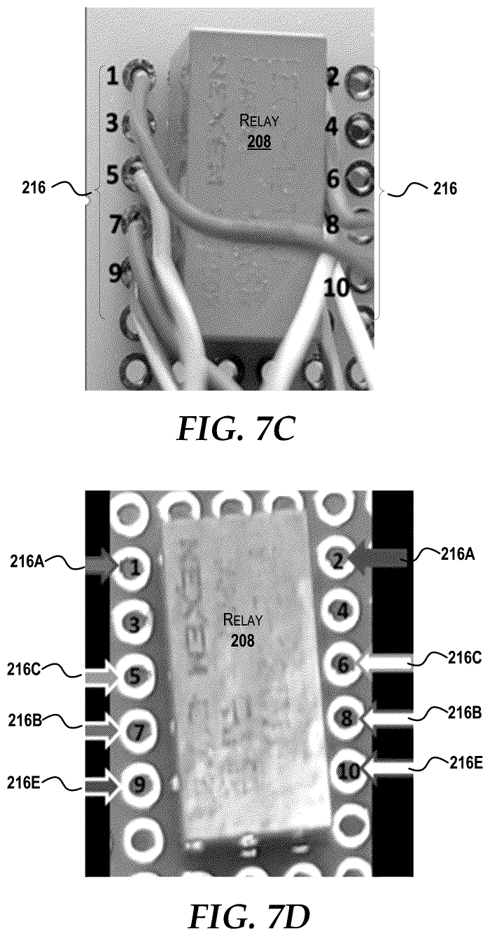

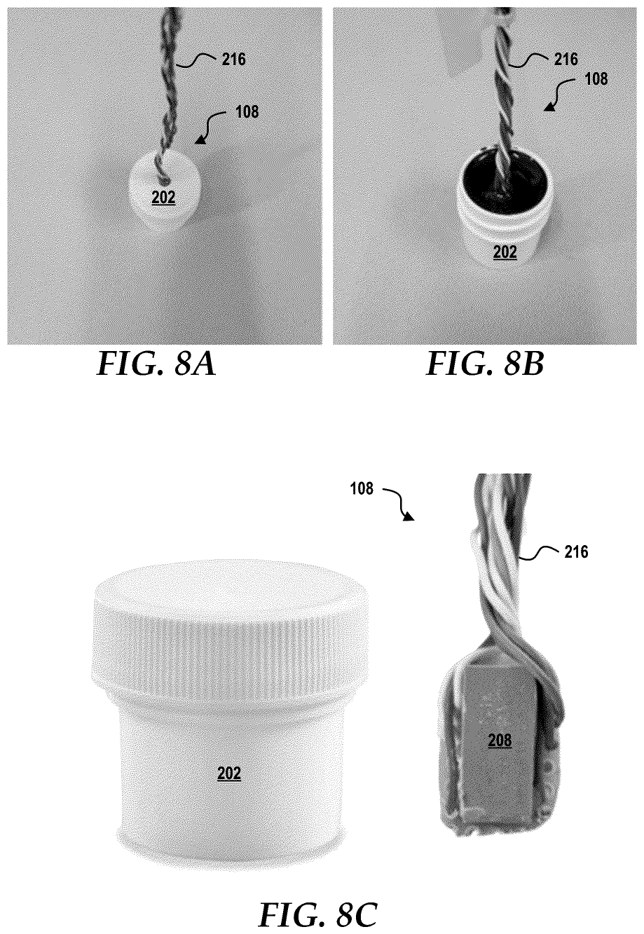

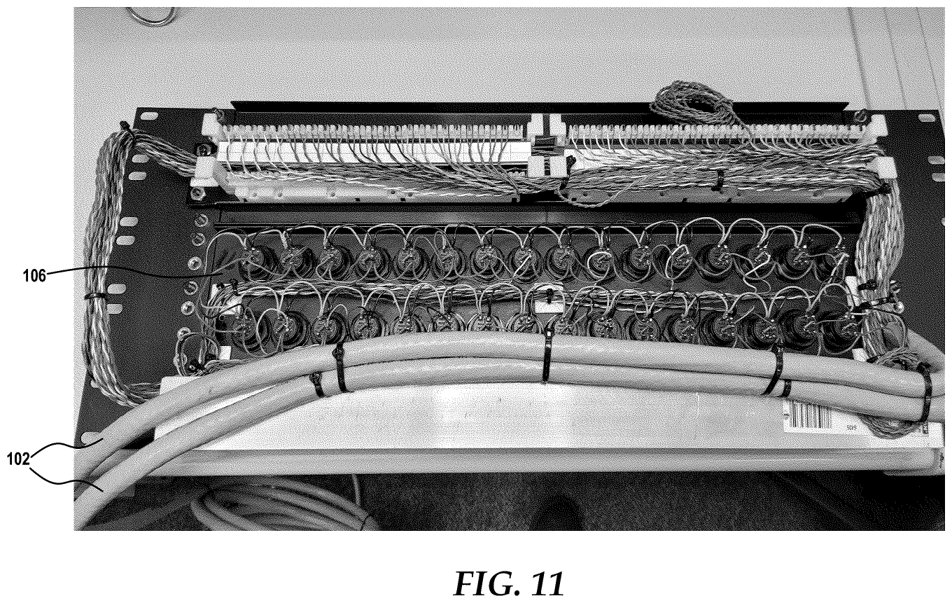

Turning now to FIGS. 6-11, several photographs of different aspects of the CCFC devices 108 and the copper cable fault training system 100 will be described. FIG. 6 is a photograph of the front and back of a printed circuit board (“PCB”) is shown. The PCB has a plurality of relays 208 soldered thereon. Each of the relays 208 is used to create one of the CCFC devices 108. FIGS. 7A and 7B are photographs of the relay wire configuration A introduced in FIG. 3A. FIGS. 7C and 7D are photographs of the relay wire configuration B introduced in FIG. 3B. FIGS. 8A-8C are photographs of completed CCFC devices 108. In particular, FIG. 8A shows a CCFC device 108 configured in accordance with the relay wire configuration A introduced in FIG. 3A, FIG. 8B shows a CCFC device 108 configured in accordance with the relay wire configuration B introduced in FIG. 3B, and FIG. 8C shows a CCFC device 108 and an example housing 202. FIG. 9 is a photograph of a classroom use case for an example copper cable fault training system 100. FIG. 10 is a photograph of an example copper cable fault training system 100. FIG. 11 is a photograph of a switch board for the copper cable fault training system 100. The switch board contains the switches 106 and the control wire pairs 110 to the CCFC devices 108 contained within the copper cable 102.

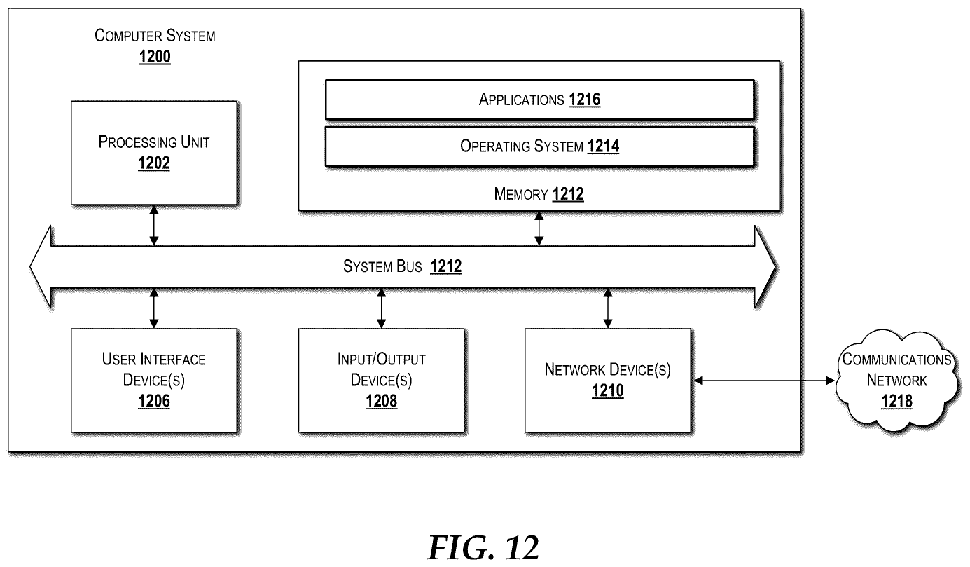

Turning now to FIG. 12, a computer system 1200 and components thereof will be described. An architecture similar to or the same as the computer system 1200 can be used to implement various systems/devices disclosed herein, such as the training computer system 220, the other system(s)/device(s) 222, one or more systems associated with the network(s) 218, and/or other systems/devices that can be used along with or in support of the concepts and technologies disclosed herein.

The computer system 1200 includes a processing unit 1202, a memory 1204, one or more user interface devices 1206, one or more input/output (“I/O”) devices 1208, and one or more network devices 1210, each of which is operatively connected to a system bus 1212. The system bus 1212 enables bi-directional communication between the processing unit 1202, the memory 1204, the user interface devices 1206, the I/O devices 1208, and the network devices 1210.

The processing unit 1202 might be a standard central processor that performs arithmetic and logical operations, a more specific purpose programmable logic controller (“PLC”), a programmable gate array, or other type of processor known to those skilled in the art and suitable for controlling the operation of the computer system 1200. Processing units are generally known, and therefore are not described in further detail herein.

The memory 1204 communicates with the processing unit 1202 via the system bus 1212. In some embodiments, the memory 1204 is operatively connected to a memory controller (not shown) that enables communication with the processing unit 1202 via the system bus 1212. The illustrated memory 1204 includes an operating system 1214 and one or more applications 1216.

The operating system 1214 can include, but is not limited to, members of the WINDOWS family of operating systems from MICROSOFT CORPORATION, the LINUX family of operating systems, the BREW family of operating systems from QUALCOMM CORPORATION, the MAC OS and/or iOS families of operating systems from APPLE INC., the FREEBSD family of operating systems, the SOLARIS family of operating systems from ORACLE CORPORATION, other operating systems such as proprietary operating systems, and the like.

The user interface devices 1206 may include one or more devices with which a user accesses the computer system 1200. The user interface devices 1206 may include, but are not limited to, computers, servers, personal digital assistants, telephones (e.g., cellular, IP, or landline), or any suitable computing devices. The I/O devices 1208 enable a user to interface with the program modules. In one embodiment, the I/O devices 1208 are operatively connected to an I/O controller (not shown) that enables communication with the processing unit 1202 via the system bus 1212. The I/O devices 1208 may include one or more input devices, such as, but not limited to, a keyboard, a mouse, a touchscreen, or an electronic stylus. Further, the I/O devices 1208 may include one or more output devices, such as, but not limited to, a display screen or a printer. An I/O device 1208 embodied as a display screen can be used to present information.

The network devices 1210 enable the computer system 1200 to communicate with a communications network 1218, which can include the network(s) 218. Examples of the network devices 1210 include, but are not limited to, a modem, a radio frequency (“RF”) or infrared (“IR”) transceiver, a telephonic interface, a bridge, a router, or a network card. The network 1218 may include a wireless network such as, but not limited to, a WLAN such as a WI-FI network, a WWAN, a wireless PAN (“WPAN”) such as BLUETOOTH, or a wireless MAN (“WMAN”). Alternatively, the network 1218 may be a wired network such as, but not limited to, a WAN such as the Internet, a LAN such as the Ethernet, a wired PAN, or a wired MAN.

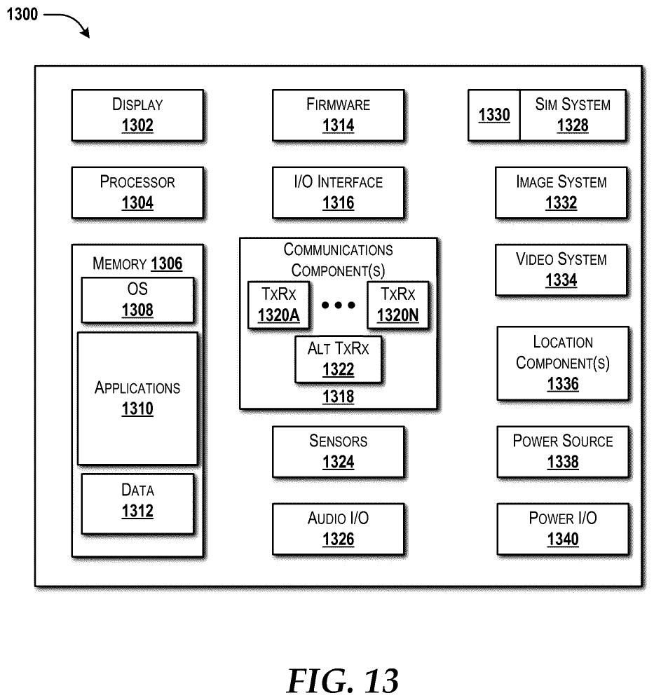

Turning now to FIG. 13, an illustrative mobile device 1300 and components thereof will be described. In some embodiments, the training computer system 220 and/or the other system(s)/device(s) 222 can be configured similar to or the same as the mobile device 1300. While connections are not shown between the various components illustrated in FIG. 13, it should be understood that some, none, or all of the components illustrated in FIG. 13 can be configured to interact with one another to carry out various device functions. In some embodiments, the components are arranged so as to communicate via one or more busses (not shown). Thus, it should be understood that FIG. 13 and the following description are intended to provide a general understanding of a suitable environment in which various aspects of embodiments can be implemented, and should not be construed as being limiting in any way.

As illustrated in FIG. 13, the mobile device 1300 can include a display 1302 for displaying data. According to various embodiments, the display 1302 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 1300 also can include a processor 1304 and a memory or other data storage device (“memory”) 1306. The processor 1304 can be configured to process data and/or can execute computer-executable instructions stored in the memory 1306. The computer-executable instructions executed by the processor 1304 can include, for example, an operating system 1308, one or more applications 1310, other computer-executable instructions stored in the memory 1306, or the like. In some embodiments, the applications 1310 also can include a UI application (not illustrated in FIG. 13).

The UI application can interface with the operating system 1308 to facilitate user interaction with functionality and/or data stored at the mobile device 1300 and/or stored elsewhere. In some embodiments, the operating system 1308 can include a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1304 to aid a user in entering/deleting data, entering and setting user IDs and passwords for device access, configuring settings, manipulating content and/or settings, multimode interaction, interacting with other applications 1310, and otherwise facilitating user interaction with the operating system 1308, the applications 1310, and/or other types or instances of data 1312 that can be stored at the mobile device 1300.

The applications 1310, the data 1312, and/or portions thereof can be stored in the memory 1306 and/or in a firmware 1314, and can be executed by the processor 1304. The firmware 1314 also can store code for execution during device power up and power down operations. It can be appreciated that the firmware 1314 can be stored in a volatile or non-volatile data storage device including, but not limited to, the memory 1306 and/or a portion thereof.

The mobile device 1300 also can include an input/output (“I/O”) interface 1316. The I/O interface 1316 can be configured to support the input/output of data such as location information, presence status information, user IDs, passwords, and application initiation (start-up) requests. In some embodiments, the I/O interface 1316 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1300 can be configured to synchronize with another device to transfer content to and/or from the mobile device 1300. In some embodiments, the mobile device 1300 can be configured to receive updates to one or more of the applications 1310 via the I/O interface 1316, though this is not necessarily the case. In some embodiments, the I/O interface 1316 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1316 may be used for communications between the mobile device 1300 and a network device or local device.

The mobile device 1300 also can include a communications component 1318. The communications component 1318 can be configured to interface with the processor 1304 to facilitate wired and/or wireless communications with one or more networks, such as the network(s) 218, the Internet, or some combination thereof. In some embodiments, the communications component 1318 includes a multimode communications subsystem for facilitating communications via the cellular network and one or more other networks.

The communications component 1318, in some embodiments, includes one or more transceivers. The one or more transceivers, if included, can be configured to communicate over the same and/or different wireless technology standards with respect to one another. For example, in some embodiments, one or more of the transceivers of the communications component 1318 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, 6G, and greater generation technology standards. Moreover, the communications component 1318 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 1318 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 1318 can include a first transceiver (“TxRx”) 1320A that can operate in a first communications mode (e.g., GSM). The communications component 1318 also can include an N^{th} transceiver (“TxRx”) 1320N that can operate in a second communications mode relative to the first transceiver 1320A (e.g., UMTS). While two transceivers 1320A-1320N (hereinafter collectively and/or generically referred to as “transceivers 1320”) are shown in FIG. 13, it should be appreciated that less than two, two, and/or more than two transceivers 1320 can be included in the communications component 1318.

The communications component 1318 also can include an alternative transceiver (“Alt TxRx”) 1322 for supporting other types and/or standards of communications. According to various contemplated embodiments, the alternative transceiver 1322 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1318 also can facilitate reception from terrestrial radio networks, digital satellite radio networks, internet-based radio service networks, combinations thereof, and the like. The communications component 1318 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1300 also can include one or more sensors 1324. The sensors 1324 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1300 may be provided by an audio I/O component 1326. The audio I/O component 1326 of the mobile device 1300 can include one or more speakers for the output of audio signals, one or more microphones for the collection and/or input of audio signals, and/or other audio input and/or output devices.

The illustrated mobile device 1300 also can include a subscriber identity module (“SIM”) system 1328. The SIM system 1328 can include a universal SIM (“USIM”), a universal integrated circuit card (“UICC”) and/or other identity devices. The SIM system 1328 can include and/or can be connected to or inserted into an interface such as a slot interface 1330. In some embodiments, the slot interface 1330 can be configured to accept insertion of other identity cards or modules for accessing various types of networks. Additionally, or alternatively, the slot interface 1330 can be configured to accept multiple subscriber identity cards. Because other devices and/or modules for identifying users and/or the mobile device 1300 are contemplated, it should be understood that these embodiments are illustrative, and should not be construed as being limiting in any way.

The mobile device 1300 also can include an image capture and processing system 1332 (“image system”). The image system 1332 can be configured to capture or otherwise obtain photos, videos, and/or other visual information. As such, the image system 1332 can include cameras, lenses, charge-coupled devices (“CCDs”), combinations thereof, or the like. The mobile device 1300 may also include a video system 1334. The video system 1334 can be configured to capture, process, record, modify, and/or store video content. Photos and videos obtained using the image system 1332 and the video system 1334, respectively, may be added as message content to an MMS message, email message, and sent to another device. The video and/or photo content also can be shared with other devices via various types of data transfers via wired and/or wireless communication devices as described herein.

The mobile device 1300 also can include one or more location components 1336. The location components 1336 can be configured to send and/or receive signals to determine a geographic location of the mobile device 1300. According to various embodiments, the location components 1336 can send and/or receive signals from global positioning system (“GPS”) devices, assisted-GPS (“A-GPS”) devices, WI-FI/WIMAX and/or cellular network triangulation data, combinations thereof, and the like. The location component 1336 also can be configured to communicate with the communications component 1318 to retrieve triangulation data for determining a location of the mobile device 1300. In some embodiments, the location component 1336 can interface with cellular network nodes, telephone lines, satellites, location transmitters and/or beacons, wireless network transmitters and receivers, combinations thereof, and the like. In some embodiments, the location component 1336 can include and/or can communicate with one or more of the sensors 1324 such as a compass, an accelerometer, and/or a gyroscope to determine the orientation of the mobile device 1300. Using the location component 1336, the mobile device 1300 can generate and/or receive data to identify its geographic location, or to transmit data used by other devices to determine the location of the mobile device 1300. The location component 1336 may include multiple components for determining the location and/or orientation of the mobile device 1300.

The illustrated mobile device 1300 also can include a power source 1338. The power source 1338 can include one or more batteries, power supplies, power cells, and/or other power subsystems including alternating current (“AC”) and/or direct current (“DC”) power devices. The power source 1338 also can interface with an external power system or charging equipment via a power I/O component 1340. Because the mobile device 1300 can include additional and/or alternative components, the above embodiment should be understood as being illustrative of one possible operating environment for various embodiments of the concepts and technologies described herein. The described embodiment of the mobile device 1300 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1300 or other devices or computers described herein. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1300 in order to store and execute the software components presented herein. It is also contemplated that the mobile device 1300 may not include all of the components shown in FIG. 13, may include other components that are not explicitly shown in FIG. 13, or may utilize an architecture completely different than that shown in FIG. 13.

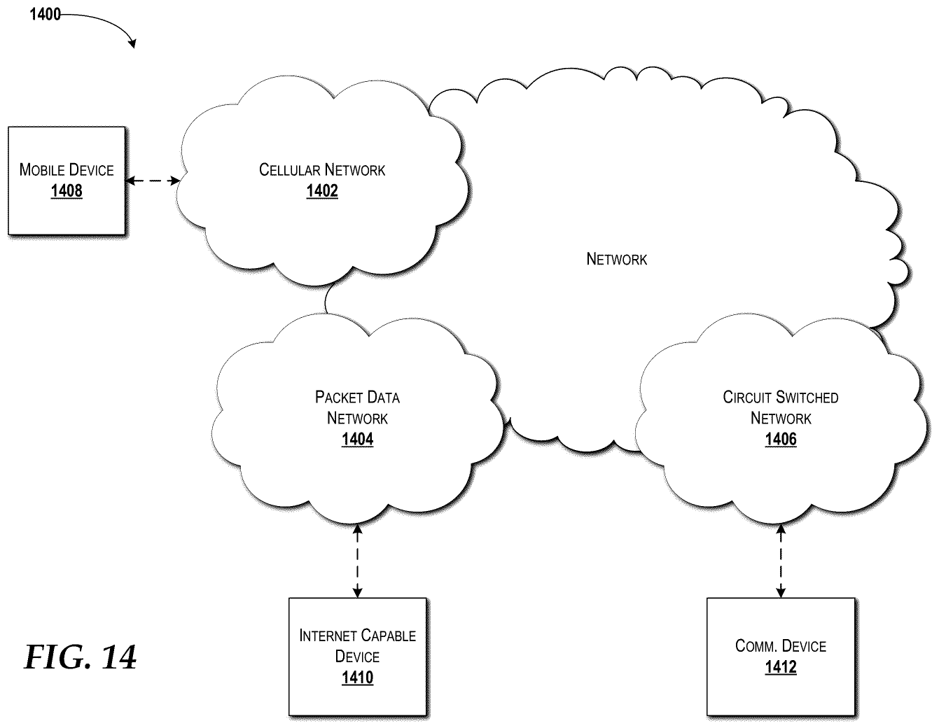

Turning now to FIG. 14, an example network 1400, such as the network 218, is illustrated, according to an illustrative embodiment. The illustrated network 106 includes a cellular network 1402, a packet data network 1404, and a circuit switched network 1406 (e.g., a public switched telephone network). The cellular network 1402 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, and the like. The cellular network 1402 also includes radios and nodes for receiving and transmitting voice, data, and combinations thereof to and from radio transceivers, networks, the packet data network 1404, and the circuit switched network 1406.

A mobile communications device 1408, such as, for example, one or more of the mobile device 1300, a cellular telephone, a user equipment, a PDA, a laptop computer, a handheld computer, and combinations thereof, can be operatively connected to the cellular network 1402. The mobile communications device 1408 can be configured similar to or the same as the mobile device 1300 described above with reference to FIG. 13.

The cellular network 1402 can be configured as a GSM network and can provide data communications via GPRS and/or EDGE. Additionally, or alternatively, the cellular network 1402 can be configured as a 3G Universal Mobile Telecommunications System (“UMTS”) network and can provide data communications via the HSPA protocol family, for example, HSDPA, EUL, and HSPA+. The cellular network 1402 also is compatible with 4G mobile communications standards such as LTE, 5G mobile communications standards, or the like, as well as evolved and future mobile standards.

The packet data network 1404 includes various systems, devices, servers, computers, databases, and other devices in communication with one another, as is generally known. In some embodiments, the packet data network 1404 is or includes one or more WI-FI networks, each of which can include one or more WI-FI access points, routers, switches, and other WI-FI network components. The packet data network 1404 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 1404 includes or is in communication with the Internet.

The circuit switched network 1406 includes various hardware and software for providing circuit switched communications. The circuit switched network 1406 may include, or may be, what is often referred to as a plain old telephone system (“POTS”). The functionality of a circuit switched network 1406 or other circuit-switched network are generally known and will not be described herein in detail.

The illustrated cellular network 1402 is shown in communication with the packet data network 1404 and a circuit switched network 1406, though it should be appreciated that this is not necessarily the case. One or more Internet-capable devices 1410 such as a laptop, a portable device, or another suitable device, can communicate with one or more cellular networks 1402, and devices connected thereto, through the packet data network 1404. It also should be appreciated that the Internet-capable device 1410 can communicate with the packet data network 1404 through the circuit switched network 1406, the cellular network 1402, and/or via other networks (not illustrated).

As illustrated, a communications device 1412, for example, a telephone, facsimile machine, modem, computer, or the like, can be in communication with the circuit switched network 1406, and therethrough to the packet data network 1404 and/or the cellular network 1402. It should be appreciated that the communications device 1412 can be an Internet-capable device, and can be substantially similar to the Internet-capable device 1410.

Based on the foregoing, it should be appreciated that concepts and technologies for a copper cable fault training system and a copper cable fault simulation device have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

1. A copper cable fault creation device comprising:
a servo comprising a servo arm;
a variable resistor physically attached to the servo arm, wherein a resistance value of the variable resistor is controlled by the servo arm, and wherein the variable resistor is electrically connected to a copper cable; and
a relay electrically connected to the variable resistor and to the copper cable,
wherein, when the relay is activated, the relay causes a fault on the copper cable.

2. The copper cable fault creation device of claim 1, wherein the relay is electrically connected to a switch via a control wire pair through which the relay is activated.

3. The copper cable fault creation device of claim 2, wherein:
when changed to a first position, the switch causes the relay to change to a first state of a plurality of states, wherein the fault comprises a first fault associated with the first state;
when the relay is activated in the first state, the relay causes the first fault on the copper cable;
when changed to a second position, the switch causes the relay to change to a second state of the plurality of states, wherein the fault comprises a second fault associated with the second state;
when the relay is activated in the second state, the relay causes the second fault on the copper cable;
when changed to a third position, the switch causes the relay to change to a third state of the plurality of states, wherein the fault comprises a third fault associated with the third state; and
when the relay is activated in the third state, the relay causes the third fault on the copper cable.

4. The copper cable fault creation device of claim 3, wherein the first fault, the second fault, and the third fault each comprise a ground fault, a short circuit fault, or a crosstalk fault.

5. The copper cable fault creation device of claim 2, wherein, when activated, the switch causes the relay to change to a specific state, and wherein the fault comprises an open circuit fault associated with the specific state.

6. The copper cable fault creation device of claim 1, further comprising a microcontroller electrically connected to the servo, wherein the microcontroller comprises instructions stored thereon that, when executed by the microcontroller, cause the microcontroller to perform operations comprising:
determining the resistance value; and
instructing the servo to adjust the variable resistor to the resistance value.

7. The copper cable fault creation device of claim 6, wherein the operations further comprise:
determining a new resistance value; and
instructing the servo to adjust the variable resistor from the resistance value to the new resistance value,
wherein, by adjusting the variable resistor from the resistance value to the new resistance value, the fault on the copper cable simulates a specific environmental condition.

8. The copper cable fault creation device of claim 7, wherein the specific environmental condition simulates a moisture condition that contributed to the fault created on the copper cable.

9. The copper cable fault creation device of claim 1, further comprising a microcontroller interface electrically connected to a microcontroller, wherein the microcontroller is electrically connected to at least one additional copper cable fault creation device.

10. A method comprising:
receiving, by a microcontroller of a copper cable fault creation device, a request to create a fault on a copper cable;
determining, by the microcontroller, a resistance value for a variable resistor and a state for a relay, wherein the resistance value and the state cause the fault to be created on the copper cable;
instructing, by the microcontroller, a servo that is physically connected to the variable resistor to adjust the variable resistor to the resistance value; and
activating, by the microcontroller, the relay to the state, thereby creating the fault on the copper cable.

11. The method of claim 10, wherein receiving the request to create the fault on the copper cable comprises receiving the request via an input device connected to the microcontroller.

12. The method of claim 10, wherein receiving the request to create the fault on the copper cable comprises receiving the request via a network connection, and wherein the network connection comprises a wireless network connection or a wired network connection.

13. The method of claim 10, wherein the request specifies the fault, at least in part, by specifying the resistance value for the variable resistor and the state for the relay.

14. The method of claim 10, further comprising programming the microcontroller with a predetermined set of faults, and wherein the request specifies the fault from the predetermined set of faults.

15. A copper cable fault training system comprising:
a copper cable;
a crossbox testing equipment connected to the copper cable;
a terminal testing equipment connected to the copper cable;
a power supply;
a plurality of switches electrically connected to the power supply; and
a plurality of copper cable fault creation devices, wherein each copper cable fault creation device of the plurality of copper cable fault creation devices is electrically connected to a switch of the plurality of switches via a control wire pair and to the copper cable, wherein each copper cable fault creation device is powered by the copper cable, and wherein each copper cable fault creation device comprises
a servo comprising a servo arm,
a variable resistor physically attached to the servo arm, wherein a resistance value of the variable resistor is controlled by the servo arm, and wherein the variable resistor is electrically connected to the copper cable, and
a relay electrically connected to the variable resistor and to the copper cable,
wherein, when the relay is activated via the switch, the relay causes a fault on the copper cable.

16. The copper cable fault training system of claim 15, wherein:
when changed to a first position, the switch causes the relay to change to a first state of a plurality of states, wherein the fault comprises a first fault associated with the first state;
when the relay is activated in the first state, the relay causes the first fault on the copper cable;
when changed to a second position, the switch causes the relay to change to a second state of the plurality of states, wherein the fault comprises a second fault associated with the second state;
when the relay is activated in the second state, the relay causes the second fault on the copper cable;
when changed to a third position, the switch causes the relay to change to a third state of the plurality of states, wherein the fault comprises a third fault associated with the third state; and
when the relay is activated in the third state, the relay causes the third fault on the copper cable.

17. The copper cable fault training system of claim 16, wherein the first fault, the second fault, and the third fault each comprise a ground fault, a short circuit fault, or a crosstalk fault.

18. The copper cable fault training system of claim 15, wherein, when activated, the switch causes the relay to change to a specific state, and wherein the fault comprises an open circuit fault associated with the specific state.

19. The copper cable fault training system of claim 15, wherein each copper cable fault creation device further comprises:
a microcontroller electrically connected to the servo, wherein the microcontroller comprises instructions stored thereon that, when executed by the microcontroller, cause the microcontroller to perform operations comprising:
determining the resistance value;
instructing the servo to adjust the variable resistor to the resistance value;
determining a new resistance value; and
instructing the servo to adjust the variable resistor from the resistance value to the new resistance value,
wherein, by adjusting the variable resistor from the resistance value to the new resistance value, the fault on the copper cable simulates a specific environmental condition.

20. The copper cable fault training system of claim 15, wherein the plurality of copper cable fault creation devices is positioned at different positions along the copper cable to simulate a plurality of faults in a real-world copper cable installation.
